(19) United States
(12) Patent Application Publication
(10) Pub. No.: US 2019/0096298 A1
(43) Pub. Date: Mar. 28, 2019

(54) DISPLAY APPARATUS AND CONTROL METHOD THEREFOR

(71) Applicant: CANON KABUSHIKI KAISHA, Tokyo (JP)

(72) Inventors: Tomokazu Mori, Fujisawa-shi (JP); Masanao Kurita, Kawasaki-shi (JP); Yasuo Suda, Yokohama-shi (JP)

(21) Appl. No.: 16/136,295

(22) Filed: Sep. 20, 2018

(30) Foreign Application Priority Data
Sep. 27, 2017 (JP) 2017-186843

(51) Int. Cl. G09G 3/00; G06T 5/00

(52) U.S. Cl. CPC G09G 3/002; G09G 2340/04; G06T 5/002

(57) ABSTRACT

Provided is a display apparatus that includes an optical modulator having a plurality of pixels and configured to modulate light from a light source and a projection optical system configured to project an optical image formed by light modulated by the optical modulator. If the optical image is to be projected onto printed matter, the sharpness of the optical image is reduced more than in a case where the optical image is not to be projected onto printed matter, and a grid pattern of the optical modulator is made indiscernible.

### BACKGROUND OF THE INVENTION

### Field of the Invention

The present invention relates to a display apparatus and a control method for controlling the display apparatus.

### Description of the Related Art

A display system with which a luminance dynamic range and a color gamut of printed matter are enhanced by projecting an image aligned with the printing content on the printed matter has been proposed (Japanese Patent Laid-Open No. 2008-83180).

A display apparatus configured to project an image includes a light source, an optical modulator configured to generate an optical image by modulating light from the light source in accordance with an image that is to be projected, and an optical system that projects the optical image. In general, the optical modulator is a transmissive or reflective display device, and displays an image to be projected, and thereby modulates the transmittance or the reflectance of light from the light source and generates an optical image. If a display device having a plurality of pixels that are arrayed in a matrix is used as the optical modulator, the boundaries of the pixels appear in the optical image as a grid-shaped pattern (referred to as “grid pattern” hereinafter), for example.

If a distance (projection distance) from the display apparatus to the printed matter (projection plane) is long, the grid pattern becomes indiscernible as the sharpness of the optical image decreases. However, when projecting an image on printed matter, the projection distance is assumed to be short. Heretofore, a method with which the grid pattern in the optical image that is projected onto printed matter is made indiscernible has not been proposed.

### SUMMARY OF THE INVENTION

The present invention has been made in view of the above-described issues. The present invention provides a display apparatus and a method for controlling the display apparatus with which a grid pattern of an optical modulator is indiscernible even when an optical image is projected onto printed matter, for example.

According to an aspect of the present invention, there is provided a display apparatus comprising: an optical modulator having a plurality of pixels and modulates light from a light source; a projection optical system that projects an optical image formed by light modulated by the optical modulator; and a controller, wherein, in a case where the optical image is to be projected onto printed matter, the controller reduces sharpness of the optical image more than in a case where the optical image is not to be projected onto printed matter.

According to another aspect of the present invention, there is provided a method for controlling a display apparatus including an optical modulator that has a plurality of pixels and modulates light from a light source and a projection optical system configured to project an optical image formed by light modulated by the optical modulator, the method comprising: reducing, if the optical image is to be projected onto printed matter, sharpness of the optical image more than in a case where the optical image is not to be projected onto printed matter.

According to a further aspect of the present invention, there is provided a non-transitory computer-readable medium storing a program executable by a computer of a display apparatus that comprises an optical modulator having a plurality of pixels and modulates light from a light source; and a projection optical system that projects an optical image formed by light modulated by the optical modulator, wherein the program, when executed by the computer, causes the computer to function as: a controller, which, in a case where the optical image is to be projected onto printed matter, reduces sharpness of the optical image more than in a case where the optical image is not to be projected onto printed matter.

Further features of the present invention will become apparent from the following description of exemplary embodiments with reference to the attached drawings.

### BRIEF DESCRIPTION OF THE DRAWINGS

FIG. 1 is a diagram that schematically shows a state in which a display apparatus according to an embodiment of the present invention is in use.

FIG. 2 is a block diagram showing a functional configuration example of a projector according to a first embodiment.

FIG. 3 is a flowchart related to operations of the projector according to the first embodiment.

FIG. 4 is a schematic diagram related to focus control for projecting onto printed matter in the first embodiment.

FIG. 5 is a block diagram showing a functional configuration example of a projector according to a second embodiment.

FIG. 6 is a schematic diagram related to an image shifting process in a second embodiment.

FIG. 7 is a flowchart related to operations of the projector according to the second embodiment.

FIG. 8 is a block diagram showing a functional configuration example of a projector according to a third embodiment.

FIG. 9 is a block diagram showing a functional configuration example of a projector according to a fourth embodiment.

FIG. 10 is a block diagram showing a functional configuration example of a projector according to a fifth embodiment.

FIG. 11 is a schematic front view and side view showing the projector according to the fifth embodiment.

FIGS. 12A to 12C are schematic diagrams related to operations of a projector according to a sixth embodiment.

FIG. 13 is a flowchart related to operations of the projector according to the sixth embodiment.

FIG. 14 is a block diagram showing a functional configuration example of a PC serving as an external control apparatus for controlling a projector according to an embodiment.

### DESCRIPTION OF THE EMBODIMENTS

Exemplary embodiments of the present invention will now be described in detail in accordance with the accompanying drawings. Note that a configuration in which the present invention is applied to a stand-alone projection display apparatus (projector) will be described in embodiments below. However, the present invention can be applied to projectors included in general electronic devices such as personal computers, smartphones, tablet terminals, game machines, and digital (video) cameras, for example. Also, in the present specification, the term “printed matter” is used as not only “printed matter” that is printed by a machine but also as a concept including any physical documents such as handwritten documents, photographic paper, and drawings.

### First Embodiment

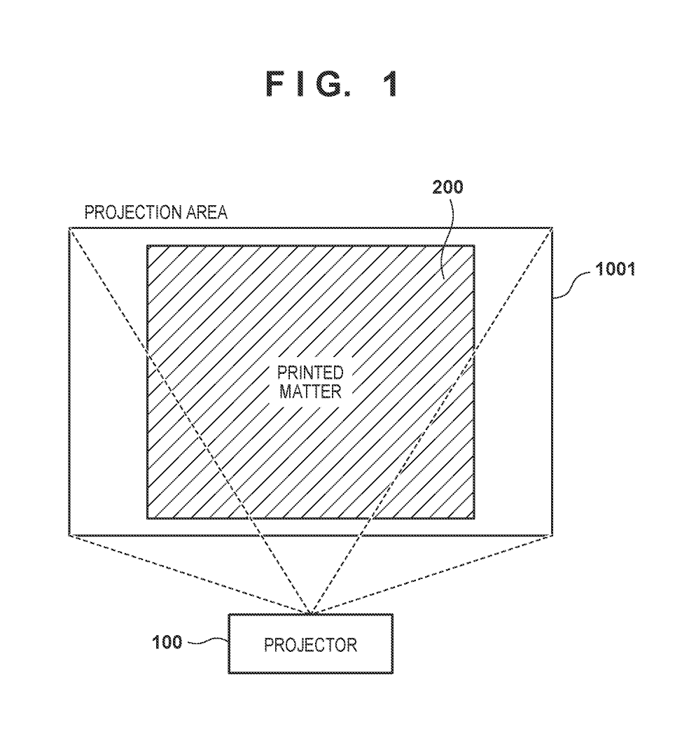

FIG. 1 schematically shows a state in which a projector 100, which is a display apparatus according to the present embodiment, is in use. In the projector 100, a liquid crystal display panel is used as an optical modulator, for example. Note that the liquid crystal display panel may be reflective or transmissive, and a single plate type or three plate type.

A range in which the projector 100 projects an image on a projection plane is a projection area 1001, and an optical image projected onto the projection area 1001 is referred to as a “projected image”. Also, in the example of FIG. 1, printed matter 200 is placed in the projection area 1001, and the projected image is aligned with the printed matter 200.

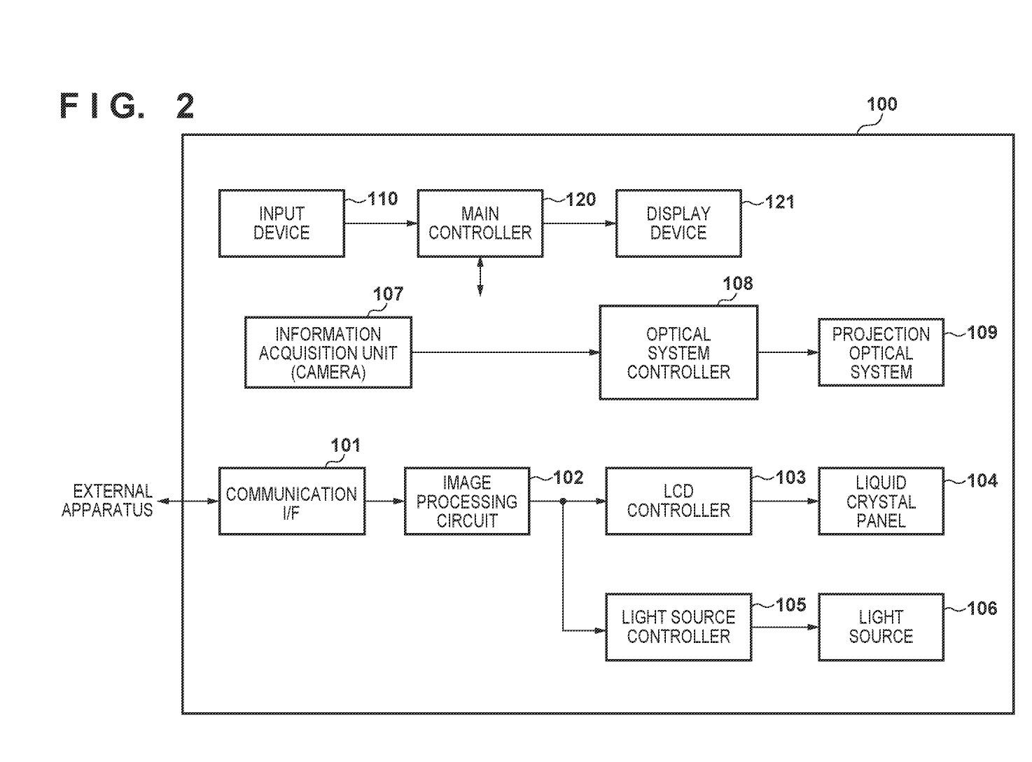

FIG. 2 is a block diagram showing a functional configuration example of the projector 100.

A main controller 120 includes one or more programmable processors, a ROM, and a RAM, and reads a program stored in the ROM or the RAM, executes the program with a programmable processor, and controls operations of each unit, and thereby realizes the functions of the projector 100. Note that the main controller 120 is connected to several blocks in FIG. 2, but is actually connected to individual units.

A communication I/F 101 is an interface for communicating with an external apparatus, and includes a communication circuit and a connector that comply with a standard to be supported. The projector 100 acquires image data (referred to as “source image data” hereinafter), which is a source of a projected image, from an external apparatus through the communication I/F 101. Herein, the external apparatus may be any devices with which the projector 100 is communicable, such as personal computers, file servers, USB memories, and cloud storages. The communication I/F 101 can support multiple wired communication standards and/or wireless communication standards. Also, commands for operating the projector 100 may be accepted from an external apparatus through the communication I/F 101.

The source image data to be acquired from the external apparatus may be selected by a user. In this case, the main controller 120 acquires a list of the source image data from the external apparatus through the communication I/F 101, and displays or projects the list on the display device 121 such that the source images can be selected. Then, the user designates desired source image data via input devices 110. Also, metadata added to the printed matter may be input using the input devices 110, or an information acquisition unit 107 may extract metadata from a captured image, and thereby the source image data may be specified. Note that the source image data will be described as still image data, but may be moving image data.

An image processing circuit 102 applies image processing to the source image data, such as noise removal, edge enhancement, scaling, or distortion correction processing (keystone correction processing), and outputs the resulting data to an LCD controller 103 or a light source controller 105. Image processing that the image processing circuit 102 can apply is not limited to processes listed above.

The LCD controller 103 generates a control signal that adjusts the transmittance or the reflectance of a liquid crystal panel 104 for each pixel based on the source image data supplied from the image processing circuit 102. Note that if the liquid crystal panel 104 is a three plate panel, the LCD controller 103 generates a control signal for each color component.

The liquid crystal panel 104 is a transmissive or reflective liquid crystal display panel having a plurality of pixels that are arrayed in a matrix. The transmittance or the reflectance of each pixel is controlled by a voltage signal output from the LCD controller 103. Because the voltage signal is based on the source image data, light that is transmitted or reflected by the liquid crystal panel 104 forms an optical image that is similar to an image expressed by the source image data.

The light source controller 105 controls on/off of the light source 106 and the light amount of the light source 106 based on a pixel value of the source image data output from the image processing circuit 102 and a user designation via the input devices 110.

The light source 106 outputs light for irradiating the liquid crystal panel 104 under the control of the light source controller 105. The light source 106 may be, for example, a halogen lamp, a xenon lamp or a high-pressure mercury lamp. If the liquid crystal panel 104 is a three plate panel, the light source 106 irradiates the liquid crystal panel with light of colors that are respectively equal to color components corresponding to the liquid crystal panel. Light of a specific color can be generated by combining a regular light source with a color filter, for example.

The information acquisition unit 107 is a sensor configured to acquire information of the printed matter 200 disposed in the projection area, and may be an image capturing apparatus (camera) configured to capture an image in a projection plane direction, for example. The information acquisition unit 107 can detect, as printed matter information, whether printed matter is present in the projection area and the size of the printed matter, a distance (projection distance) from the projector 100 to the projection plane, and the like. The projection distance can be detected as an in-focus distance, for example. Also, whether printed matter is present can be detected by comparing an image captured in a state in which no printed matter is disposed with an image captured at the time of detection processing, for example. Also, the size of the printed matter can be detected based on an area of a rectangular object detected in the captured image. The information acquisition unit 107 communicates the detection result to the optical system controller 108 and the main controller 120.

Note that the information acquisition unit 107 may detect the projection distance, and the image processing circuit 102 may detect whether printed matter is present and the size of the printed matter. In this case, it is sufficient that the information acquisition unit 107 outputs the captured image to the image processing circuit 102, and the image processing circuit 102 communicates the detection result to the main controller 120.

The optical system controller 108 changes the focal length (magnification) and the in-focus distance of a projection optical system 109 according to the printed matter information supplied from the information acquisition unit 107 or under the control of the main controller 120.

The projection optical system 109 includes a plurality of lenses including a magnification adjusting lens and a focus lens, and projects an optical image formed by light that is transmitted or reflected by the liquid crystal panel 104. The optical system controller 108 has a driving mechanism for moving the magnification adjusting lens or the focus lens along the optical axis, and drives the magnification adjusting lens and the focus lens under the control of the optical system controller 108 or the main controller 120.

The input devices 110 is the generic name of input devices such as buttons, switches, and dials that are provided on a case, for example. If the display device 121 is a touch display, a touch panel portion of the display device 121 constitutes the input devices 110. A user can designate data of a source image to be projected onto the printed matter 200, control on/off of the light source 106 and the light amount of the light source 106, control the magnification and focus of the projection optical system 109, designate a projection mode of the projector 100, and the like, via the input devices 110. The projection mode will be described later.

Note that at least some of the items that can be instructed from the input devices 110 can be remotely instructed from an external apparatus through the communication I/F 101. If the main controller 120 receives an instruction from the external apparatus, the main controller 120 also handles it similarly to an instruction received from the input devices 110.

The display device 121 is a liquid crystal display panel, for example, and can display information of the projector 100, information acquired from an external apparatus, a menu screen, and the like, under the control of the main controller 120.

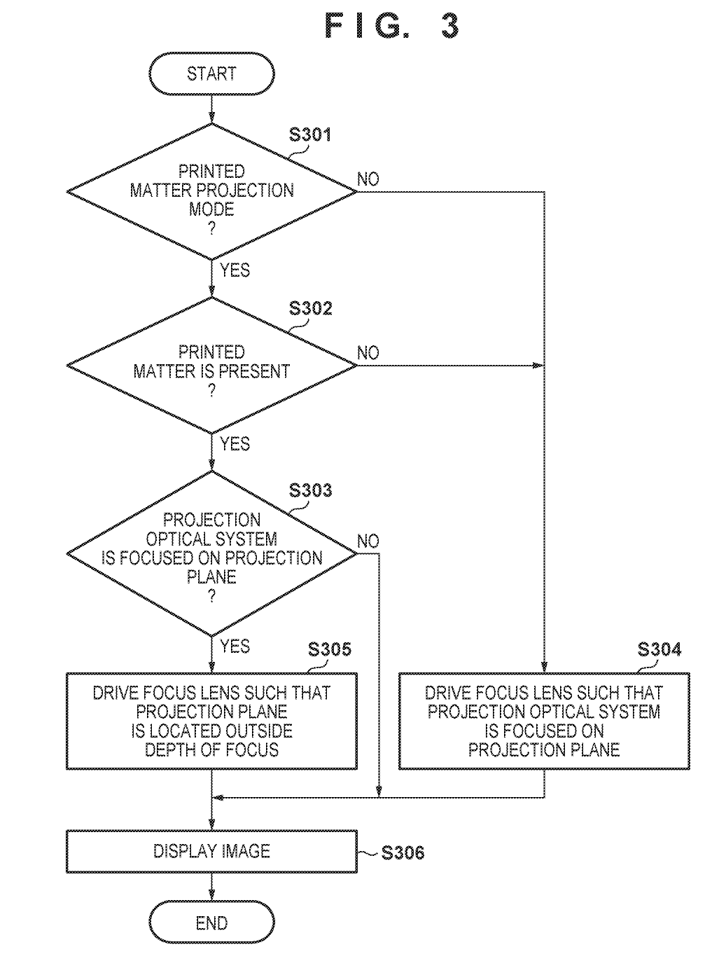

FIG. 3 is a flowchart related to display operations of the projector 100.

The projector 100 according to the present embodiment can select “printed matter projection mode” and “normal projection mode” as a projection mode, and the main controller 120 executes a projection operation corresponding to the projection mode.

The “printed matter projection mode” is a mode for enhancing a dynamic range or a color gamut of printed matter through projection on the printed matter.

The “normal projection mode” is a mode with which normal projection is performed, and its purpose is not an enhancement of the dynamic range or the color gamut of printed matter.

The operations shown in FIG. 3 are executed after the power source of the projector 100 is turned on and initial processing ends, for example, but may be executed at another predetermined timing when the projection mode is set, for example.

In step S301, the main controller 120 determines whether or not the projection mode is set to the printed matter projection mode, and if it is determined that the projection mode is set to the printed matter projection mode, the main controller 120 advances processing to step S302, and if it is determined that the projection mode is not set to the printed matter projection mode, the main controller 120 advances processing to step S304.

In step S302, the main controller 120 determines whether or not printed matter is present in the projection area, and if it is determined that printed matter is present in the projection area, the main controller 120 advances processing to step S303, and if it is determined that no printed matter is present in the projection area, the main controller 120 advances processing to step S304. Specifically, first, the main controller 120 request information acquisition unit 107 of the printed matter information. The information acquisition unit 107 captures an image in accordance with a request, and communicates the detected printed matter information to the main controller 120. Note that information related to whether printed matter is present is sufficient to capture an image, and thus the main controller 120 may project a menu screen or display the menu screen on the display device 121, and inquire of the user about the presence of printed matter, for example. Then, the main controller 120 executes determination of step S302 in accordance with whether printed matter that was input by the user via the input devices 110 is present.

In step S303, the main controller 120 determines whether or not the projection optical system is focused on the projection plane, and if it is determined that the projection optical system is focused thereon, the main controller 120 advances processing to step S305, and if it is determined that the projection optical system is not focused thereon, the main controller 120 advances processing to step S306. For example, if it is determined that the projection plane is located in the depth of focus of the projection optical system (or the circle of confusion on the projection plane is less than or equal to a permissible circle of confusion), the main controller 120 can determine that the projection optical system is focused on the projection plane. The in-focus distance and the depth of focus can be obtained from parameters such as a permissible circle of confusion, a projection distance included in the printed matter information, an F-value and a focal length of the projection optical system. Alternatively, the main controller 120 may execute known autofocus control using a contrast method based on an image, captured by the information acquisition unit 107, that is focused on the projection plane, focus the projection optical system on the projection plane, and determine that the projection optical system is focused on the projection plane. Note that the projection optical system being in focus at a certain distance refers to the amount of bokeh of the projected image at this distance being less than or equal to a permissible circle of confusion.

In step S305, the main controller 120 drives the focus lens of the projection optical system 109 through the optical system controller 108 such that the projection plane is located outside the depth of focus of the projection optical system (or the circle of confusion on the projection plane exceeds the permissible circle of confusion). That is, the sharpness of the projected image is reduced from the best condition (the amount of bokeh of the projected image is increased). Accordingly, it is possible to make the grid pattern of pixel boundaries indiscernible.

Note that how much the projection plane deviates from the depth of focus (how much to increase the amount of bokeh of the projected image) can be defined in advance such that a decrease in the sharpness of the projected image and indiscernibility of the grid pattern of pixel boundaries are balanced. Specifically, the amount of focus lens movement from a focus position (shift amount) can be defined in advance in accordance with a plurality of combinations of projection distances and F-values of the projection optical system, and be stored in the ROM of the main controller 120, for example. Then, the main controller 120 can refer to the ROM based on the current combination of the projection distance and the F-value, acquire a shift amount corresponding to the nearest combination, and instructs the optical system controller 108 to drive the focus lens together with the shift amount. Note that if a combination that coincides with the current combination is not stored, shift amounts corresponding to nearest two combinations may be interpolated so as to obtain a shift amount. Note that the shift amount may be defined with other conditions such as light amount taken into consideration. Also, if the F-value of the projection optical system is fixed, the F-value need not be considered. The focus lens movement direction can be defined in advance in accordance with the state of bokeh in the movement direction, for example, (which will be described later).

On the other hand, in step S304, the main controller 120 drives the focus lens through the optical system controller 108 such that the projection optical system 109 is focused on the projection plane, and advances processing to step S306. Note that if autofocus is not set, the main controller 120 need not drive the focus lens in step S304.

If the user inputs an instruction to change the in-focus distance (manual focus operation) through the input devices 110, the main controller 120 may prioritize the user instruction rather than the control in steps S304 and S305.

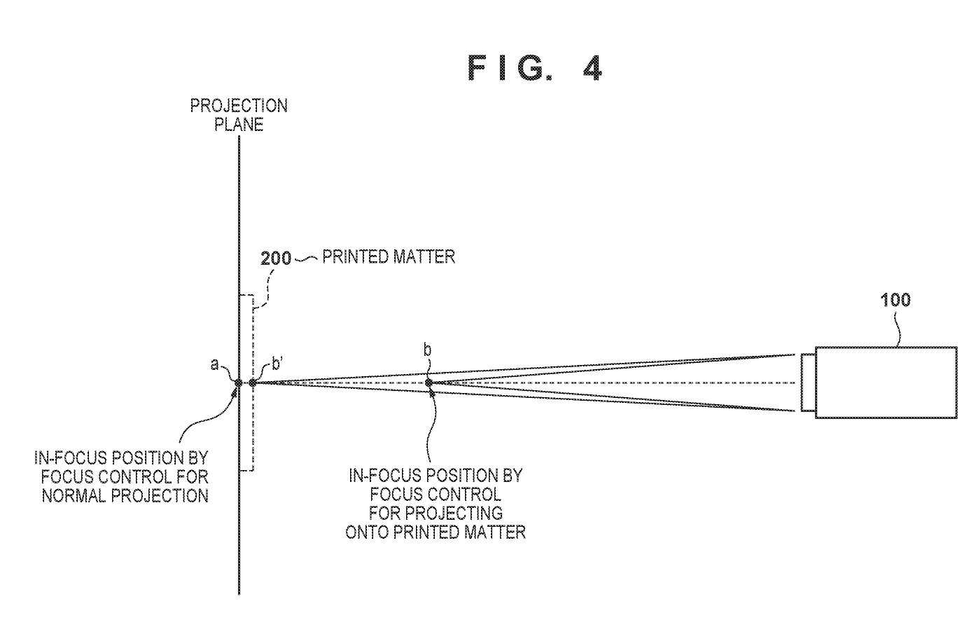

FIG. 4 is a diagram that schematically shows the focus position after the projection optical system is controlled in steps S303 and S304 (focus control).

If it is determined that the projection mode is the normal projection mode and that the projection mode is the printed matter projection mode and there is no printed matter (step S304), the in-focus distance of the projection optical system is controlled such that the projection plane is included in the depth of focus. Thus, the focus lens of the projection optical system 109 is driven such that the projection optical system 109 is focused on a position a (projection plane) in FIG. 4, for example.

On the other hand, if it is determined that the projection mode is the printed matter projection mode and printed matter is present in the projection area (step S303), the in-focus distance of the projection optical system is controlled such that the printed matter 200 (projection plane) is located outside the depth of focus. Thus, the focus lens of the projection optical system 109 is driven such that the projection optical system 109 is focused on a position b instead of a position b′ at which the projection optical system 109 is focused on the printed matter 200, for example. In this manner, if an image is projected onto printed matter, focus control for projecting printed matter is performed on the projection optical system such that the sharpness of the projected image is reduced (the amount of bokeh is increased) more than in a case where an image is to be projected onto the projection plane with no printed matter.

Note that the position b is depicted to be located in front of the position b′ viewed from the projector 100 in FIG. 4, but may be a position located backward of the position b′. For example, if spherical aberration of the lens of the projection optical system is insufficiently corrected, a line in the projected image looks double, so-called “two line bokeh”, sometimes occurs depending on a direction in which the focus position shifts. Thus, which of the front side (near side) and the back side (infinity side) to move the position b with respect to the position b′ such that the two line bokeh is unlikely to appear may be measured in advance, and a direction in which the in-focus distance shifts (the focus lens moves) may be determined based on the measured values.

Lastly, in step S306, the main controller 120 controls the image processing circuit 102, the LCD controller 103, and the light source controller 105 so as to project an image that is based on the source image data acquired through the communication I/F 101. Accordingly, light from the light source 106 is modulated by the liquid crystal panel 104 in accordance with the source image data, and the optical image formed by transmitted light and reflected light is projected onto the projection plane.

As described above, according to the present embodiment, if an image is projected onto printed matter, the focus of the projection optical system is controlled such that the sharpness of the projected image is reduced (the amount of bokeh is increased) more than in the case where an image is to be projected onto the projection plane having no printed matter. Thus, even though an image is projected onto printed matter that is located at a close distance by a projection display apparatus using an optical modulator in which a plurality of pixels are two-dimensionally arrayed, it is possible to make the pattern of pixel boundaries indiscernible.

In the present embodiment, a configuration was described in which if it is determined that the printed matter projection mode is set and there is printed matter, focus control is executed to reduce the sharpness of a projected image (increase the amount of bokeh) more than in a case where the normal projection mode is set or a case where it is determined that there is no printed matter. However, a configuration may be adopted in which if the printed matter projection mode is set, focus control for projecting printed matter is executed to reduce the sharpness of a projected image (increase the amount of bokeh) without checking the presence of printed matter.

Also, a projection mode (printed matter projection mode or normal projection mode) need not be provided, and if it is determined that printed matter is present in the projection area, focus control for projecting printed matter may be executed.

When an observation distance (distance between a user and a projection plane) is long, the grid pattern of the projected image is indiscernible. Also, it is thought that when the projection distance (distance between a projector and the projection plane) is long, the observation distance is also long. Thus, if the projection distance acquired by the information acquisition unit 107 is more than or equal to a first predetermined value that is sent in advance, focus control for projecting printed matter need not be performed, and if the projection distance is less than a second predetermined value, focus control for projecting printed matter may be performed. Note that the first predetermined value and the second predetermined value may be the same or different from each other (however, first predetermined value>second predetermined value holds true). If the first predetermined value and the second predetermined value are different from each other, with regard to a range that is less than the first predetermined value and a range that is more than or equal to the second predetermined value, as described above, whether or not focus control for projecting printed matter is performed may be determined using one or more of the projection mode and the result of determining whether there is printed matter.

Note that if the projector 100 includes a remote controller capable of acquiring distance information, the information acquisition unit 107 may execute the above-described operation using the distance (observation distance) between the remote controller and the projection plane, acquired from the remote controller.

Note that operating such that focus control for projecting printed matter is not performed during processing for aligning a projected image makes it possible to align the projected image without the influence of a decrease in the sharpness of the projected image caused by focus control for projecting printed matter. After alignment processing ends, focus control for projecting printed matter need not be executed until the user gives an explicit instruction, or focus control for projecting printed matter may be automatically executed. Note that whether or not alignment processing is being performed can be determined by whether or not a mode of the projector 100 is set to an alignment projection mode, or whether or not execution of alignment processing is instructed by a menu operation, for example.

Note that if a manual focus operation or an automatic focus operation is performed after focus control for projecting printed matter is performed, the grid pattern may be discernible. Thus, the in-focus state of the projection optical system may be monitored after focus control for projecting printed matter is performed, and if it is determined that the projection plane is in the depth of focus, an inquiry about whether to execute focus control for projecting printed matter again may be made to the user. Alternatively, a configuration may be adopted in which focus control for projecting printed matter is automatically executed without making an inquiry. Note that focus control for projecting printed matter may be executed in accordance with a user instruction through a menu operation or a dedicated button operation.

Also, instead of operating the input devices 110, a command corresponding to operating the input devices 110 may be transmitted from an external apparatus connected communicably through the communication I/F 101, and the projector 100 may be remotely operated.

### Second Embodiment

Next, a second embodiment of the present invention will be described below. The first embodiment has a configuration in which the sharpness of a projected image is reduced (or the amount of bokeh is increased) by adjusting the focus position of the projection optical system, and thereby the grid pattern is made indiscernible. In contrast, the present embodiment has a configuration in which the pixel grid is made indiscernible by projecting an image with the pixel positions shifted.

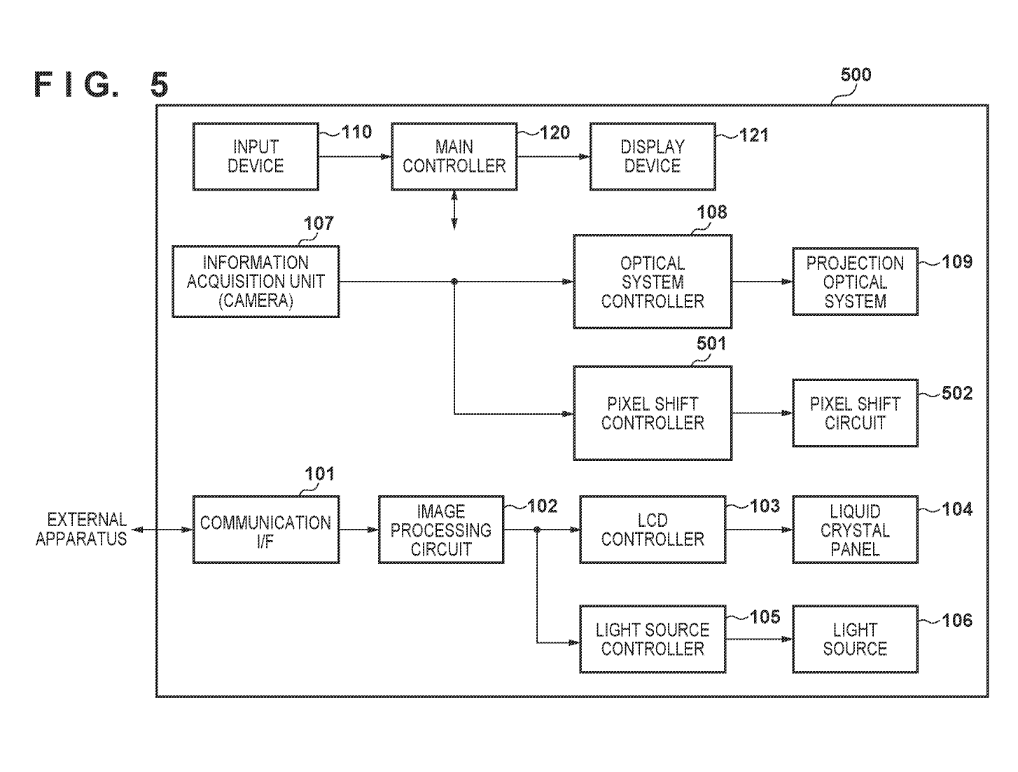

FIG. 5 is a block diagram showing a functional configuration example of a projector 500 according to the present embodiment. Note that in FIG. 5, functional blocks that are the same as those of the projector 100 of the first embodiment are given the same reference numerals as in FIG. 2. Hereinafter, the second embodiment will be described about differences from the first embodiment.

If the main controller 120 has determined to execute focus control for projecting printed matter, a pixel shift controller 501 drives an actuator of a pixel shift circuit 502 so as to shift pixels of the projected image, and thereby makes the grid pattern of the projected image indiscernible.

The pixel shift circuit 502 is constituted by parallel flat plate glass disposed perpendicularly to an optical path of light that is transmitted or reflected by the liquid crystal panel 104, and an actuator that move the parallel flat plate glass in a plane perpendicular to the optical path. By moving the parallel flat plate glass, the optical path shifts due to refraction of light and a position at which the projected image is projected moves. By changing the projection position over time, the projected image is observed as an image whose sharpness decreases, like a camera shake image. A mechanism for controlling optical path shift by the actuator can be realized by applying a known technique such as a feedback control using a sensor, for example. The parallel plate glass is an example of an optical path shift device for deflecting the optical path. Note that optical path shift may be realized by another configuration in which a ferroelectric liquid crystal panel is used as the optical path shift device, and the optical path shifts due to an electric field that is applied, for example. Note that the pixel shift controller 501 and the pixel shift circuit 502 are expressed as independent functional blocks in FIG. 5, but in reality, they may have an integrated structure. Hereinafter, processing for changing a projected image position using optical path shifting is referred to as a second pixel shifting process.

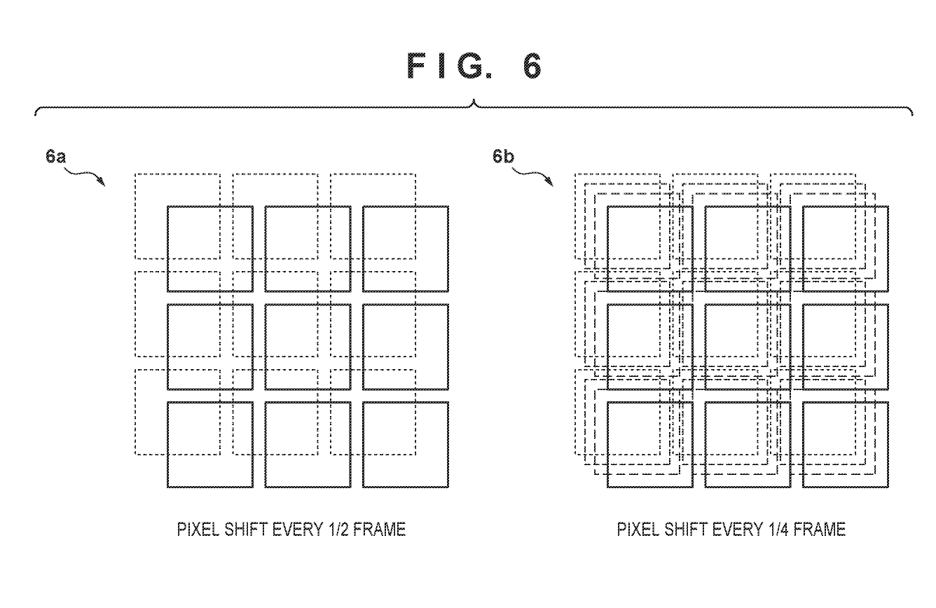

FIG. 6 is a diagram that schematically shows the effect of the pixel shifting process. In FIG. 6, 6a schematically shows superimposition of a 3×3 pixel area of a projected image and the 3×3 pixel area of the projected image obtained by subjecting the projected image to optical path shifting in a ½ frame cycle through the pixel shifting process. The grid patterns caused by pixel boundaries (gap areas) overlap each other and are alternately displayed over time, and thus a time division diffusion effect acts on human vision, and the grid pattern becomes indiscernible. Note that in 6a, if a display frequency of a source frame is 60 Hz (60 fps), a display frequency of a sub-frame will be 120 Hz (120 fps). Herein, “sub-frame” refers to projected images that are generated in one frame cycle and whose projection positions are different from each other.

Note that although a pixel shifting process is used to obtain, using a projector, a projection image having a resolution that is higher than with a light valve, in this case, it is necessary to use a shift amount of 0.5 pixels in horizontal and vertical directions. However, there is no such restriction on a pixel shift amount in the pixel shifting process of the present embodiment. For example, the pixel shift amount need only be the minimum shift amount or more for overlapping a pixel area and a gap area that are defined by an opening ratio of the liquid crystal panel 104 and the width of a black matrix (gap area). An upper limit of the pixel shift amount can be defined in advance within a range in which a decrease in the sharpness of the projected image is acceptable. Hereinafter, a pixel shifting process for increasing the resolution of a projected image is referred to as a first pixel shifting process. Also, a pixel shifting process for making a grid pattern of the projected image indiscernible is referred to as a second pixel shifting process.

In FIG. 6, 6b schematically shows superimposition of a 3×3 pixel area of a projected image and the 3×3 pixel area of the projected image obtained by subjecting the projected image to optical path shifting in a ¼ frame cycle. In 6b, if a display frequency of a source frame is 60 Hz (60 fps), a display frequency of a sub-frame will be 240 Hz (240 fps). In this case, a time period in which the grid pattern is displayed at the same location is half the time period of 6a, and thus the grid pattern becomes more indiscernible. In this manner, the grid pattern can be made more indiscernible by shortening a cycle of one instance of optical path shifting in the second pixel shifting process (increasing the display frequency of the sub-frame).

In the present embodiment, one frame cycle is divided into a plurality of sub-frames, and the optical path is shifted in each sub-frame cycle. A plurality of patterns of the number of sub-frame cycles per frame cycle, the shift amount and the shift direction of the optical path (a position at which the optical path shift device is driven in the present embodiment) can be stored in the ROM of the main controller 120 or the like. The main controller 120 selects one of the plurality of patterns in accordance with a user setting, the projection distance, and the like, and controls the pixel shift controller 501. For example, if the projection distance or the observation distance is more than or equal to a threshold, the grid pattern is more indiscernible than in a case where the projection distance or the observation distance is less than the threshold, and thus it is possible to extend the sub-frame cycle (reduce the number of sub-frame cycles per frame cycle).

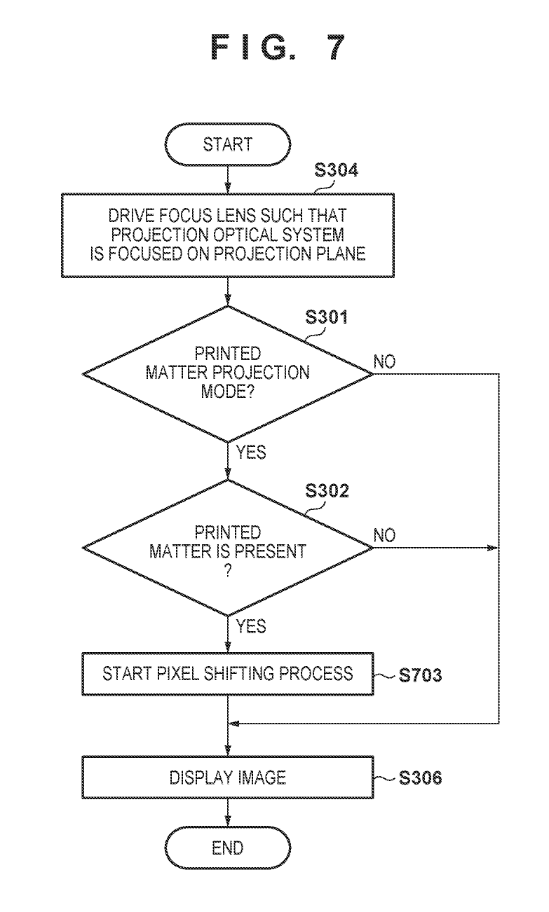

FIG. 7 is a flowchart related to display operations of the projector 500 according to the present embodiment.

Although the “printed matter projection mode” and the “normal projection mode” can also be selected as a projection mode in the present embodiment, the projection mode is also not essential in the present embodiment, similarly to the first embodiment. Also, steps in which processes that are similar to those of the first embodiment are performed are given the same reference numerals as in FIG. 3.

In the present embodiment, first, step S304 is executed, and the projection optical system is focused on the projection plane (on printed matter if there is printed matter).

Thereafter, in steps S301 and S302, a determination about whether or not the projection mode is the printed matter projection mode, and a determination about whether or not there is printed matter are executed.

If it is determined that the projection mode is the printed matter projection mode and there is printed matter (if it is determined to execute the second pixel shifting process), the main controller 120 advances processing to step S703, and advances processing to step S306 in other cases.

In step S703, the main controller 120 causes the pixel shift controller 501 and the pixel shift circuit 502 to designate a pattern of optical path shifting and start the second pixel shifting process. Note that if the first pixel shifting process is being executed, the main controller 120 switches to the second pixel shifting process.

In this manner, the second pixel shifting process for making the grid pattern of the projected image that is caused by pixel boundaries indiscernible is executed in projection on printed matter, and if no image is projected onto the printed matter, the sharpness of the projected image is prioritized and the second pixel shifting process is not performed.

As described in the first embodiment, in step S306, the main controller 120 controls the image processing circuit 102, the LCD controller 103, and the light source controller 105 so as to project an image that is based on source image data acquired through the communication I/F 101.

According to the present embodiment, if an image is projected onto printed matter, a pixel shifting process for reducing the sharpness of a projected image (increasing the amount of bokeh) is executed. Thus, similarly to the first embodiment, even though an image is projected onto printed matter that is located at a close distance by a projection display apparatus using an optical modulator in which a plurality of pixels are two-dimensionally arrayed, it is possible to make the pattern of pixel boundaries indiscernible.

In the present embodiment, a configuration was described in which if it is determined that the printed matter projection mode is set and there is printed matter, an operation for reducing the sharpness of a projected image are executed. However, a configuration may be adopted in which an operation for reducing the sharpness of a projected image is executed without checking the presence of printed matter if the printed matter projection mode is set. Also, a configuration may be adopted in which a projection mode (printed matter projection mode or normal projection mode) is not provided, and if it is determined that printed matter is present in the projection area, an operation for reducing the sharpness of a projected image is executed.

When an observation distance (distance between a user and a projection plane) increases, the grid pattern of the projected image become more indiscernible. Also, it is thought that when the projection distance (distance between a projector and the projection plane) is long, the observation distance is also long. Thus, if the projection distance acquired by the information acquisition unit 107 is more than or equal to a preset first predetermined value, an operation for reducing the sharpness of the projected image need not be executed, and if the projection distance is less than a second predetermined value, an operation for reducing the sharpness of the projected image may be executed. Note that the first predetermined value and the second predetermined value may be the same or different from each other (however, first predetermined value>second predetermined value holds true). If the first predetermined value and the second predetermined value are different from each other, with regard to a range that is less than the first predetermined value and a range that is more than or equal to the second predetermined value, as described above, whether or not an operation for reducing the sharpness of the projected image is executed may be determined using one or more of the projection mode and the result of determining whether there is printed matter.

Note that if the projector 100 includes a remote controller capable of acquiring distance information, the information acquisition unit 107 may execute the above-described operation using the distance (observation distance) between the remote controller and the projection plane that has been acquired from the remote controller.

Note that operating such that the second pixel shifting process is not performed during processing for aligning a projected image makes it possible to align the projected image without influence of a decrease in the sharpness of the projected image caused by the pixel shifting process. After alignment processing ends, the second pixel shifting process need not be executed until the user gives an explicit instruction, or the second pixel shifting process may be automatically resumed. Note that whether or not alignment processing is being performed can be determined by whether or not a mode of the projector 500 is set to an alignment projection mode, or whether or not execution of alignment processing is instructed by a menu operation, for example.

Also, a command corresponding to operating the input devices 110 may be transmitted from an external apparatus connected communicably through the communication I/F 101, and the projector 100 may be remotely operated, instead of operating the input devices 110.

### Third Embodiment

Next, a third embodiment of the present invention will be described below. The present embodiment has a configuration in which whether or not processing for reducing the sharpness of a projected image (or increasing the amount of bokeh), which was described in the first and second embodiments, is executed is dynamically determined in accordance with the content of the projected image.

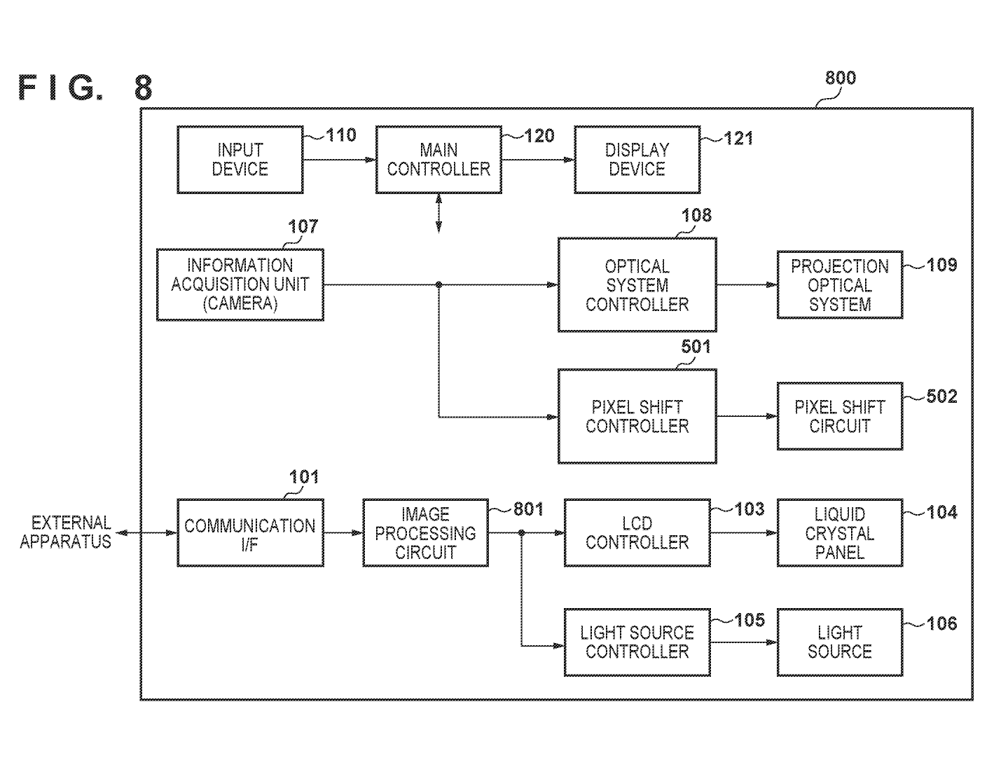

FIG. 8 is a block diagram showing a functional configuration example of a projector 800 according to the present embodiment. Note that in FIG. 8, functional blocks that are the same as the projectors 100 and 500 of the first and second embodiments are given the same reference numerals as in FIGS. 2 and 5. The projector 800 can execute both operations for reducing the sharpness of a projected image that were described in the first and second embodiments.

An image processing circuit 801 calculates a space frequency characteristic (space frequency spectrum, for example) as a feature amount of source image data that has been received from an external apparatus through an communication I/F 101 or an image of printed matter in a captured image acquired by the information acquisition unit 107, for example. Then, the calculated image feature amount is output to the main controller 120.

In the present embodiment, if a ratio or an amount of predetermined high-frequency components exceed a threshold, the main controller 120 determines that the grid pattern in the projection image is indiscernible, and does not execute processing for reducing the sharpness of the projected image (or increasing the amount of bokeh). On the other hand, if the ratio or the amount of the predetermined high-frequency components is less than or equal to the threshold, the main controller 120 determines that the grid pattern in the projection image is discernible, and executes processing for reducing the sharpness of the projected image (or increasing the amount of bokeh).

Herein, the processing for reducing the sharpness of the projected image (or increasing the amount of bokeh) may be focus control to shift the in-focus distance of the projection optical system in the first embodiment, or the second pixel shifting process in the second embodiment.

The present embodiment corresponds to calculating a feature amount related to the source image data or the image of printed matter in the captured image immediately before or after step S302 in FIGS. 3 and 7, and adding a step of determining whether or not the ratio or the amount of the high-frequency components exceeds a threshold, for example. Then, if it is determined that the ratio or the amount of the high-frequency components exceeds the threshold, the main controller 120 moves processing to steps S304 (FIG. 3) or S306 (FIG. 7). On the other hand, if it is determined that the ratio or the amount of the high-frequency components is less than or equal to the threshold, the main controller 120 advances processing to step S302 or step S303/S703.

The step for determining whether or not the ratio or the amount of the high-frequency components exceeds the threshold may be used instead of at least one of the step of determining whether the printed matter projection mode is set (step S301) and the step of determining whether or not there is printed matter (step S302) in the first and second embodiments.

Note that the feature amount that is used to determine whether or not the processing for reducing the sharpness of the projected image (or increasing the amount of bokeh) is executed may be a luminance distribution of pixels. For example, if the variance of luminance values is small or if luminance values of many pixels are in a narrow luminance range, there is a high possibility that the projected image will be a flat image (an image having a low ratio or a small amount of the high-frequency components). In this case, the grid pattern is discernible, and thus it can be determined to execute the processing for reducing the sharpness of the projected image (or increasing the amount of bokeh).

According to the present embodiment, whether or not the processing for reducing the sharpness of the projected image (or increasing the amount of bokeh) is executed is determined based on whether or not the grid pattern of an image to be projected or printed matter on which an image is projected is discernible. Thus, it is possible to suppress an unnecessary decrease in the sharpness of the projection image.

### Fourth Embodiment

Next, a fourth embodiment of the present invention will be described below.

In a projector, an operation menu or a message is projected as an on-screen display (OSD). In this case, an image obtained by superimposing the image of the OSD on a source image is projected, and thus if processing for reducing the sharpness of a projected image (or increasing the amount of bokeh) is being executed, the sharpness of the OSD also decreases.

A configuration in which whether or not processing for reducing the sharpness of a projected image (or increasing the amount of bokeh) is executed is determined in accordance with the content of the projected image was described in the third embodiment. Similarly to this, the present embodiment has a configuration in which whether or not the processing for reducing the sharpness of a projected image (or increasing the amount of bokeh) is executed is controlled depending on the OSD is being displayed.

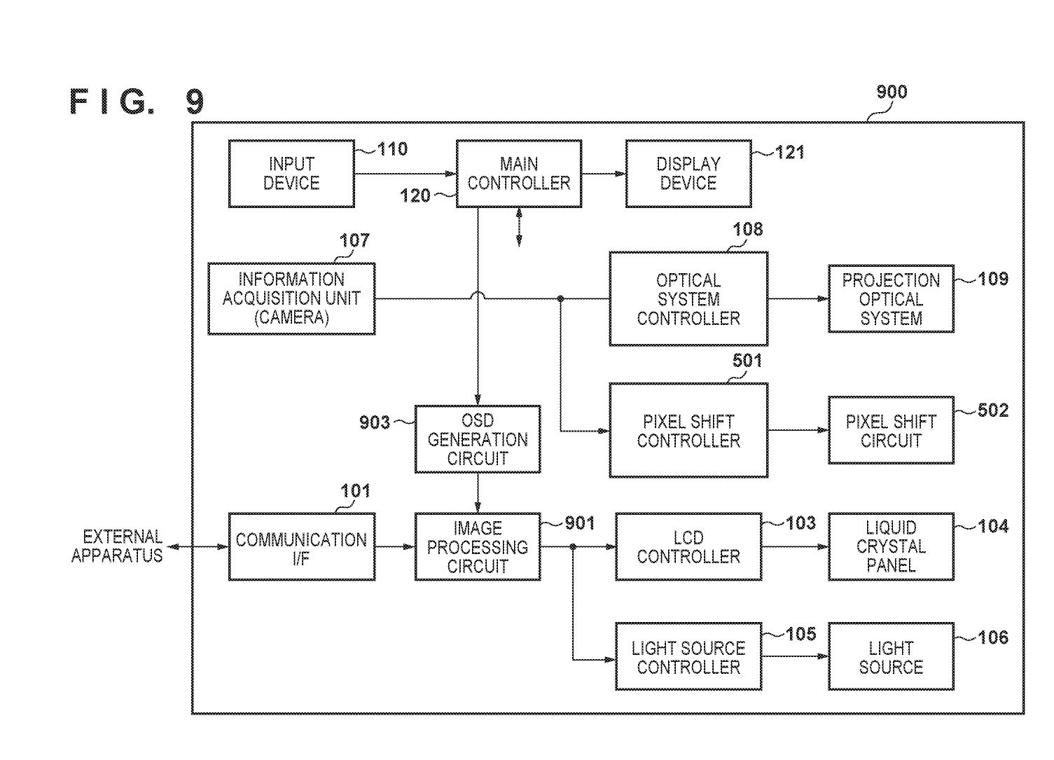

FIG. 9 is a block diagram showing a functional configuration example of a projector 900 according to the present embodiment. Note that in FIG. 9, functional blocks that are the same as those of the projectors 100 and 500 of the first and second embodiments are given the same reference numerals as in FIGS. 2 and 5. The projector 900 can execute any of the operations for reducing the sharpness of a projected image that were described in the first and second embodiments.

A main controller 120 detects the occurrence of a predetermined event related to generation of the OSD. The events related to the generation of the OSD refers to an event in which a message for the purpose of warning or checking is displayed, and an event in which a menu screen, various setting screens, or the like are displayed to visually feed back operating these screens, for example. The content of the OSD corresponding to the content of an event is stored in the ROM of the main controller 120, for example. When the main controller 120 detects the occurrence of an event related to the generation of the OSD, the main controller 120 instructs the OSD generation circuit 903 to generate an image of the OSD corresponding to the detected event.

The OSD generation circuit 903 generates the OSD image corresponding to the instruction issued by the main controller 120, and outputs the generated image to an image processing circuit 901. Also, when the OSD generation circuit 903 outputs the OSD image, the OSD generation circuit 903 sets an OSD status signal that indicates whether or not the OSD is being displayed at a High level (referred to as “H” hereinafter) indicating that the OSD is being displayed. The OSD status signal is input to the main controller 120 and the image processing circuit 901. If the OSD is not displayed, the OSD generation circuit 903 sets the OSD status signal to a Low level (referred to as “L” hereinafter).

The image processing circuit 901 superimposes the OSD image generated by the OSD generation circuit 903 on a predetermined position (center, for example) of an image (source image) of source image data received from an external apparatus though the communication I/F 101 and outputs the resulting image. Note that the image processing circuit 901 may generate the above-described OSD status signal. In this case, the image processing circuit 901 outputs an OSD status signal having H while superimposing the OSD image on the source image, and outputs an OSD status signal having L while not superimposing the OSD image thereon.

The main controller 120 controls the optical system controller 108 and the pixel shift controller 501 such that an operation for reducing the sharpness of a projected image is not executed while the OSD status signal is in H. That is, if the focus position of the projection optical system 109 is shifted (the first embodiment), the main controller 120 executes an autofocus operation such that the projection plane is located in the depth of focus of the projection optical system 109. Also, if the second pixel shifting process is executed (the second embodiment), the main controller 120 instructs the pixel shift controller 501 to suspend the second pixel shifting process. This makes it possible to suppress difficulty in viewing display of the OSD.

Similarly to the third embodiment, for example, the present embodiment corresponds to adding a step of determining whether or not the OSD is being displayed (whether or not the OSD status signal is in H) immediately before or after step S302 of FIGS. 3 and 7. Then, if it is determined that the OSD is being displayed (the OSD status signal is in H), the main controller 120 moves processing to steps S304 (FIG. 3) or S306 (FIG. 7). On the other hand, if it is determined that the OSD is not being displayed (the OSD status signal is in L), the main controller 120 advances processing to step S302 or step S303/S703.

Note that the present embodiment can be combined with the third embodiment. In this case, an operation for reducing the sharpness of the projected image is executed in one of:
(1) a case where a printed matter projection mode is set,
(2) a case where printed matter is present in a projection area, in addition to (1), and
(3) a case where it is determined that printed matter is present in the projection area, regardless of (1), and
(4) if it is determined that an amount or a ratio of high-frequency components on a surface of printed matter on which an image is to be projected or source image data is less than or equal to a threshold, and this operation is not executed in other cases.

Note that a configuration in which the operation for reducing the sharpness of a projected image is always stopped while the OSD is being displayed was described in the present embodiment. However, a configuration may be adopted in which the operation for reducing the sharpness of a projected image is stopped only while a specific predetermined OSD is being displayed. For example, a configuration is possible in which a display priority is set for each type of OSD in advance, and the operation for reducing the sharpness of a projected image is stopped only while an OSD with a display priority that is higher than a predetermined reference value is being displayed.

According to the present embodiment, whether or not the processing for reducing the sharpness of a projected image (or increasing the amount of bokeh) is executed is determined based on whether or not the OSD is being displayed. Thus, similarly to the third embodiment, it is possible to suppress an unnecessary decrease in the sharpness of the projection image.

### Fifth Embodiment

Next, a fifth embodiment of the present invention will be described below.

The fourth embodiment has a configuration in which whether or not processing for reducing the sharpness of a projected image (or increasing the amount of bokeh) is executed is controlled by whether or not an OSD is being displayed. In the present embodiment, utilizing a difference between sharpnesses of a projection image makes the grid pattern indiscernible and suppresses a decrease in the visibility of an OSD.

For example, if a projection optical system has a short focal length and has a short projection distance, or if an angle between a projection plane and an optical axis is not 90 degrees, the sharpness (or the amount of bokeh) has a difference in the projected image due to optical characteristics, an optical path length, and the like of the projection optical system. In such a case, control is performed such that an OSD is displayed at a position at which sharpness is higher than (or a position at which the amount of bokeh is less than) at other positions, and thereby a decrease in the display visibility of an OSD while executing the second focus shifting process.

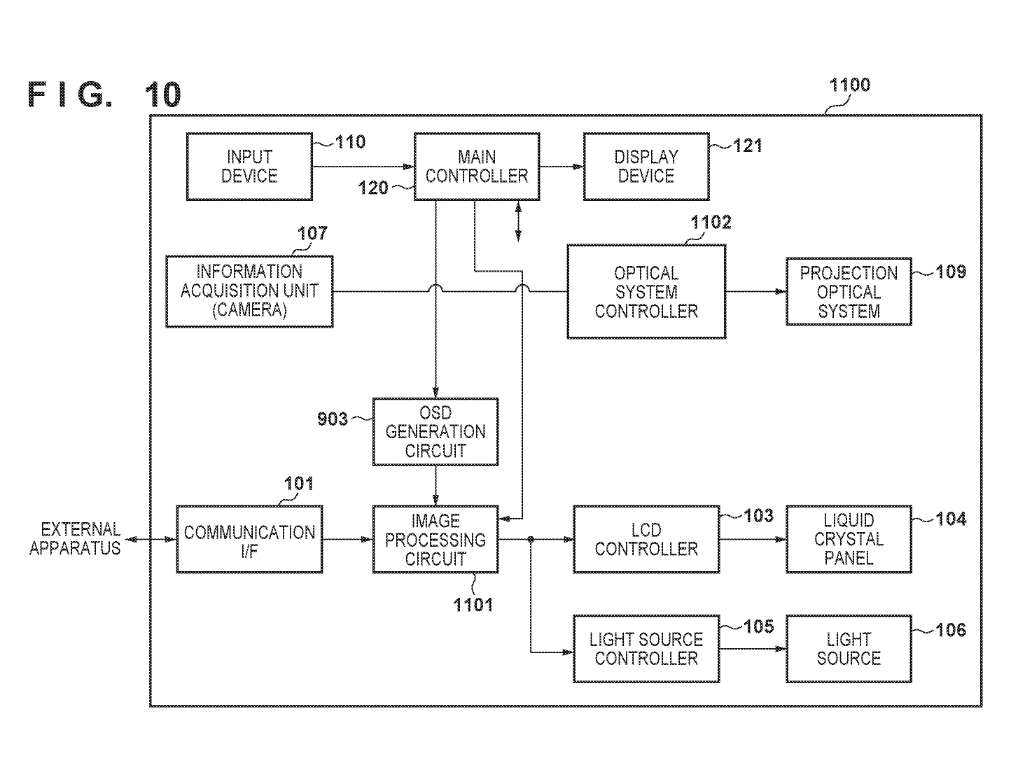

FIG. 10 is a block diagram showing a functional configuration example of a projector 1100 according to the present embodiment. Note that in FIG. 10, configurations that were described in the first and fourth embodiments are given reference numerals that are similar to those of FIGS. 2 and 9.

Similarly to the optical system controller 108 described in the first embodiment, an optical system controller 1102 drives a zoom lens and a focus lens of a projection optical system 109 under the control of the main controller 120. The optical system controller 1102 also communicates information related to the focal length and the in-focus distance of the projection optical system 109 to the main controller 120.

The main controller 120 determines an OSD superimposition position based on the information of the projection optical system 109 that is obtained from the optical system controller 1102 and information related to optical characteristics of the projection optical system 109 that are stored in advance, position information of the projection plane, and the like, and communicates the OSD superimposition position to an image processing circuit 1101.

The image processing circuit 1101 superimposes the image received from an OSD generation circuit 903 on a source image in accordance with the superimposition position determined by the main controller 120 and outputs the resulting image.

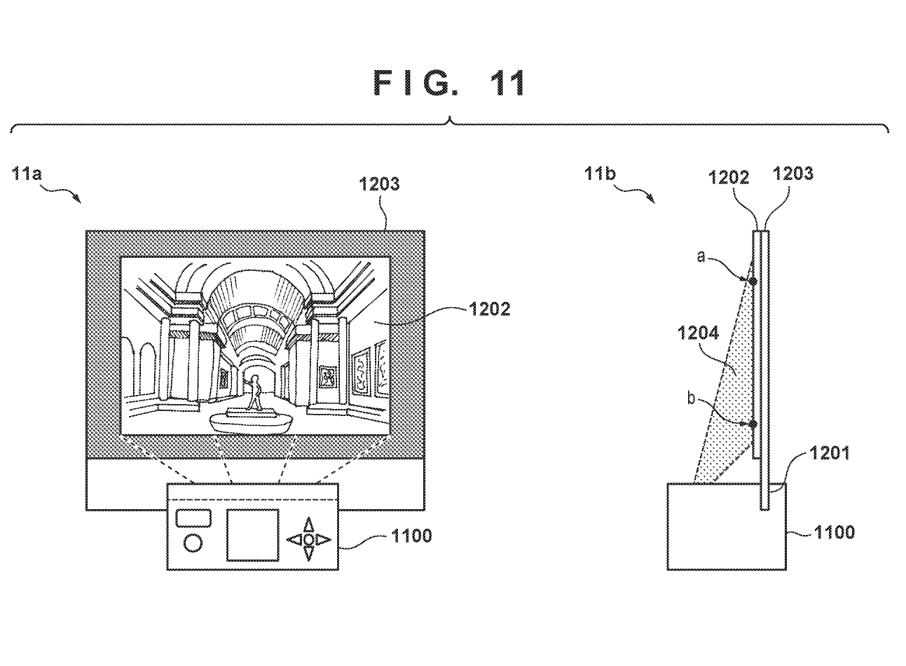

Next, a method for the main controller 120 determining the OSD display position will be described with reference to FIG. 11. In FIG. 11, 11a is a schematic diagram of a state in which the projector 1100 projects an image on printed matter, viewed from the front of the projection plane. The projector 1100 is provided with a printed matter holding portion 1201 for fixing printed matter 1202 held by a photo frame 1203. 11b is a diagram of the state of 11a, viewed from the right side. A projection optical system 109 of the projector 1100 projects an optical image on the printed matter 1202, and reference numeral 1204 schematically shows the optical path of luminous flux forming the optical image.

In this manner, in a configuration in which the optical axis of the projection optical system 109 and the projection plane are not orthogonal to each other, a difference between sharpnesses (or amounts of bokeh) caused by positions on a projection image is studied. As viewed from the projector 1100, a position a on the projected image is farther than a position b, and thus the sharpness of the projected image at the position a is lower than that at the position b. Alternatively, the amount of bokeh at the position a is larger than the amount of bokeh at the position b.

In the present embodiment, similarly to the first embodiment, the main controller 120 executes focus control for projecting printed matter in which an in-focus distance of the projection optical system 109 is controlled such that the projection plane (an upper surface of printed matter) is not located in the depth of focus of the projection optical system 109 if an image is projected onto the printed matter. If an OSD is displayed during execution of focus control for projecting printed matter, the main controller 120 then determines a display position such that the OSD is displayed at a position at which the sharpness is higher than that of the other positions in a projected image (a position at which the amount of bokeh is smaller than that of the other positions).

The main controller 120 calculates the amount of bokeh (defocus amount) in each of a plurality of areas obtained by dividing the projected image in the horizontal direction and the vertical direction based on the focal length, optical characteristics, a projection distance, and the like of the projection optical system 109, for example. Then, the main controller 120 determines the OSD display position such that the defocus amount includes the minimum area, and communicates the OSD display position to the image processing circuit 1101.

Note that as shown in FIG. 11, if a positional relationship between the projection optical system 109 and a projection plane (photo frame 1203) is known, a plurality of focal lengths that the projection optical system 109 may be stored in a ROM of the main controller 120 or the like, in association with the OSD display positions. Alternatively, the sharpness of a projected image is higher in an area having a shorter optical path length, and thus the main controller 120 may determine the OSD display position such that the OSD is displayed in an area having a short projection distance. That is, if the positional relationship between the projection optical system 109 and the projection plane is fixed, the main controller 120 determines the same position (the lowest area in the example of FIG. 11) as the OSD display position and always gives an instruction to the image processing circuit 1101.

Alternatively, the main controller 120 may measure a distance from the projection optical system 109 in the projection area based on a known measurement method, and determine an area that is located closest thereto as the OSD display position. For example, the area that is located closest can be specified from the distribution of the amounts of bokeh in an image obtained by the information acquisition unit 107 capturing the projection plane.

As described above, according to the present embodiment, if a difference arises in the sharpness of the projection image due to the positional relationship between the projection plane and the projection optical system, for example, the OSD is displayed at a position at which the sharpness is better. Thus, even though focus control for projecting printed matter is executed, for example, a decrease in the sharpness of the OSD display can be suppressed.

### Sixth Embodiment

The fifth embodiment has a configuration in which if an OSD is displayed during execution of focus control for projecting printed matter under a projection condition where the sharpness of a projected image (or the amount of bokeh) becomes non-uniform, the OSD is displayed at a position at which the sharpness of the projected image does not decrease much. The present embodiment has a configuration in which the effect of suppressing the grid pattern of a projected image while the OSD is not displayed is increased by combining the configuration of the fifth embodiment with lens shifting.

Because the present embodiment can be implemented using the projector 1100 described in the fifth embodiment, the present embodiment will be described using the configuration of the projector 1100 hereinafter.

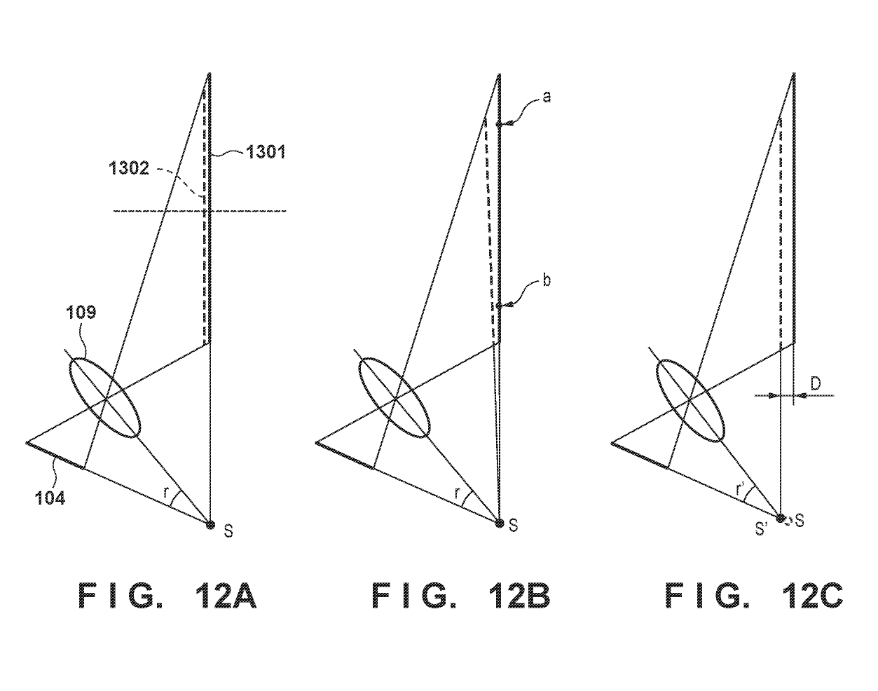

FIGS. 12A to 12C are diagrams that schematically show influences of an angle between the projection optical system 109 and a projection plane on the defocus state of the projected image.projection plane.

A display surface of the liquid crystal panel 104 that is an optical modulator, a lens main flat surface and the in-focus plane 1302 of the projection optical system 109 intersect at the same point S or point S′ due to the Scheimpflug principle. In FIGS. 12A to 12C, a tilt angle of the projection optical system 109 is expressed by r or r′, and a distance between the projection plane 1301 and the in-focus plane 1302 (defocus amount) is expressed by D. The “tilt angle” of the projection optical system 109 refers to an angle formed between the display surface of the liquid crystal panel 104 and the lens main surface of the projection optical system 109.

FIG. 12A shows a state in which the projection optical system 109 is focused on the projection plane 1301 due to focus control for normal projection, and the projected image has the highest sharpness in this state.

On the other hand, FIG. 12B shows a state in which the in-focus distance of the projection optical system 109 is controlled by focus control for projecting printed matter such that the projection plane 1301 is located outside the depth of focus of the projection optical system 109. Herein, the tilt angle r of the projection optical system 109 does not change. In this case, similarly to the fifth embodiment, the distance between the in-focus plane 1302 and the projection plane 1301 is not constant, and thus bokeh (or sharpness) of the projection image is not uniform. The amount of bokeh at a position a is larger than the amount of bokeh at a position b, the distance from the in-focus plane 1302 to the position a being larger than the distance from the in-focus plane 1302 to the position b.

FIG. 12C shows a state in which the tilt angle r of the projection optical system 109 is changed to r′ without changing the position of the focus lens of the projection optical system 109 from the state of FIG. 12A. When the tilt angle changes from r to r′, the point S moves to the point S′, and the in-focus plane 1302 moves to a position at a distance D while the in-focus plane 1302 is kept parallel to the projection plane 1301. That is, by changing the tilt angle of the projection optical system 109, instead of changing the position of the focus lens, it is possible to uniformly reduce the sharpness of the projected image.

Herein, OSD display during execution of focus control for projecting printed matter will be considered.

In FIG. 12B, it is assumed that the amount of bokeh that is sufficient to make the grid pattern indiscernible is obtained at the position a, and that the amount of bokeh is insufficient at the position b having a less amount of bokeh than at the position a, for example. In this case, as described in the fifth embodiment, an OSD is displayed at the position b, and thereby a decrease in the sharpness of the OSD can be suppressed. However, from the viewpoint of focus control for projecting printed matter, it is not desirable that the grid pattern is visible at the position b if the OSD is not displayed.

In the present embodiment, focus control for projecting printed matter is executed when the OSD is displayed, and the projection optical system 109 is tilted when the OSD is not displayed. This makes it possible to increase the effect of suppressing the grid pattern of a projected image when the OSD in the configuration of the fifth embodiment is not displayed.

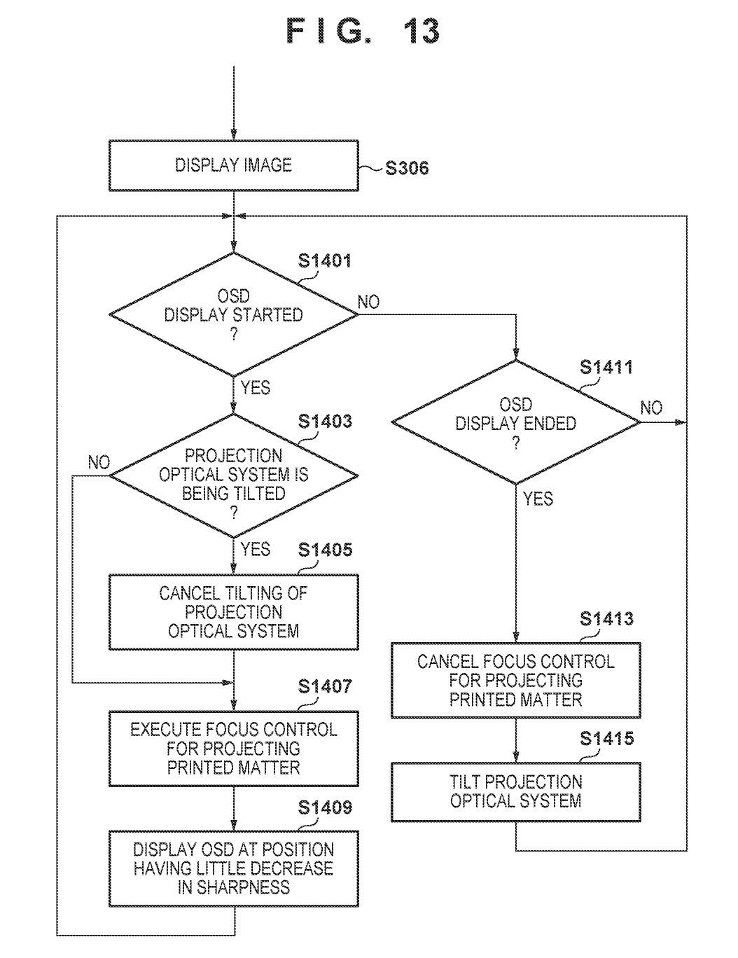

FIG. 13 is a flowchart related to an OSD display operation in the present embodiment. Herein, OSD display is assumed as an example, the OSD being displayed after focus control for projecting printed matter is executed in step S305 in the first embodiment, processing moves to step S306, and then an image is displayed. Note that the lens main surface (or optical axis) of the projection optical system 109 can be tilted, and the tilt angle can be changed by the main controller 120 through the optical system controller 108.

In step S1401, the main controller 120 determines, based on an OSD status signal, for example, whether or not OSD display has been started, and if it is determined that OSD display has been started, the main controller 120 advances processing to step S1403, and if it is determined that OSD display has not been started, the main controller 120 advances processing to step S1411.

In step S1403, the main controller 120 determines whether or not the projection optical system 109 is currently being tilted, and if it is determined that the projection optical system 109 is being tilted, the main controller 120 advances processing to step S1405, and if it is determined that the projection optical system 109 is not tilted, the main controller 120 advances processing to step S1407. Herein, “being tilted” refers to a state in which the tilt angle is r′ from r in FIGS. 12A to 12C. The tilt angle of the projection optical system 109 can be acquired through the optical system controller 108.

In step S1405, the main controller 120 cancels the tilt of the projection optical system 109. Specifically, the main controller 120 instructs the optical system controller 108 to change the tilt angle of the projection optical system 109 from r′ to r. Canceling the tilt results in the state of FIG. 12A from FIG. 12C.

In step S1407, the main controller 120 executes focus control for projecting printed matter. Canceling the tilt of the projection optical system 109 results in the state in which the in-focus plane 1302 coincides with the projection plane 1301 (FIG. 12A). Thus, similarly to step S305 of the first embodiment, the main controller 120 drives the focus lens of the projection optical system 109, and reduces the sharpness of the projected image. When focus control for projecting printed matter is performed, a relationship between the in-focus plane 1302 and the projection plane 1301 has a state of FIG. 12B.

As described in the fifth embodiment, in step S1409, the main controller 120 determines a position at which there is not much decrease in the sharpness caused by focus control for projecting printed matter, as a position at which to superimpose the image of the OSD on the projected image, and controls OSD display. Thereafter, the main controller 120 returns processing to step S1401.

On the other hand, in step S1411, the main controller 120 determines whether or not OSD display has ended, based on an OSD status signal, for example, and if it is determined that OSD display has ended, the main controller 120 advances processing to step S1413, and if it is determined that OSD display has not ended, the main controller 120 returns processing to step S1401.

In step S1413, the main controller 120 cancels focus control for projecting printed matter. That is, the main controller 120 drives the focus lens such that the in-focus plane 1302 of the projection optical system 109 coincides with the projection plane 1301. Canceling of focus control for projecting printed matter may be substantially similar to the autofocus operation.

In step S1415, the main controller 120 then tilts the projection optical system 109 at an angle defined in advance. Specifically, the main controller 120 instructs the optical system controller 108 to change the tilt angle of the projection optical system 109 from r to r′. The tilt angle may be the minimum angle at which the projection plane 1301 is located outside the depth of focus of the projection optical system 109, for example. Tilting of the projection optical system 109 results in the state of FIG. 12C from FIG. 12A. Thereafter, the main controller 120 returns processing to step S1401.

In this manner, according to the present embodiment, shifting the projection optical system and changing the in-focus distance of the projection optical system can be selectively executed as a method for reducing the sharpness of a projection image. Also, shifting the projection optical system is executed when an OSD is not displayed, and changing the in-focus distance of the projection optical system is executed when the OSD is displayed. Thus, it is possible to suppress a decrease in the sharpness of the OSD while reducing visibility of the grid pattern.

Note that similarly to focus control for projecting printed matter in the first embodiment and the second pixel shifting process in the second embodiment, a method for reducing the sharpness of a projected image by tilting the projection optical system can be implemented independently.

### Other Embodiments

In the above-described embodiments, a configuration was described in which a controller of a projector determines whether or not the sharpness of a projected image is reduced, and the controller controls an optical system controller, a pixel shift controller, and the like such that the sharpness of the projected image decreases. However, a configuration may be adopted in which the controller of the projector controls the optical system controller, the pixel shift controller, and the like so as to reduce the sharpness of the projected image, by an instruction issued from an external control apparatus such as an information processing apparatus or an image capturing apparatus, for example. For example, the controller sets a projection mode of the projector in a printed matter projection mode in response to a printed matter projection mode setting request received through an output unit or a communication unit of the external control apparatus. Alternatively, when receiving a grid pattern suppression instruction through the output unit or the communication unit of the external control apparatus, the controller can execute any of the above-described processes for reducing the sharpness of the projected image.

Also, the external control apparatus may realize processing that is similar to that of the above-described embodiments by switching an image signal for projection that is to be output to the projector.

Specifically, the external control apparatus may transmit an image signal whose sharpness is reduced more than in a case where an optical image is not to be projected onto printed matter to the projector through the output unit or the communication unit. That is, if it is detected that the projector or the external control apparatus is set to the printed matter projection mode, the external control apparatus may apply image processing for reducing the sharpness and transmit the image signal to the projector through the output unit or the communication unit.

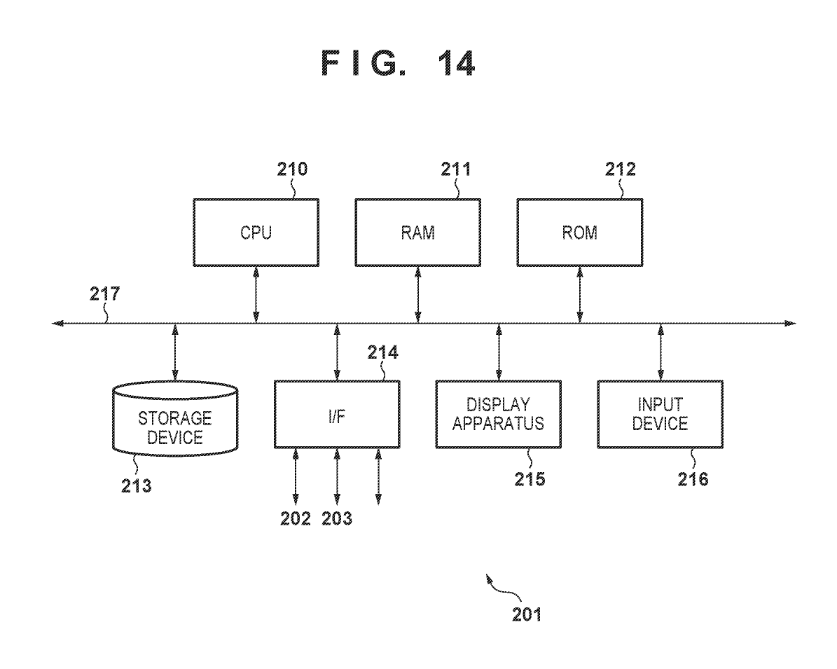

FIG. 14 is a block diagram that schematically shows a functional configuration example of a general purpose computer apparatus (PC 201), which is an example of an electronic device that can be utilized as the external control apparatus of the projector 100.

The CPU 210 is one or more programmable processors, and realizes the functions of the PC 201 by loading an OS, application programs, or the like that are stored in a ROM 212 or a storage device 213, on a RAM 211, and executing the loaded OS or programs. The CPU 210 may include a display controller or a GPU. Note that operations that are mainly performed by the PC 201 are in actuality realized by the CPU 210 executing programs.

The RAM 211 is used to load a program executed by the CPU 210, store temporal information of a program, and temporarily buffer data. Part thereof may be used as a video memory of a display apparatus 215.

The ROM 212 stores programs executed by the CPU 210, various setting values, parameters, GUI data, and the like. The ROM 212 may be rewritable.

The storage device 213 stores the OS, application programs, data files, and the like. The storage device 213 may be a hard disk drive, a solid state drive, or the like.

An I/F 214 is a communication interface with an external device, and in general, is constituted by a group of interfaces that conform to a plurality of standards. For example, the I/F 214 may include a wired communication interface conforming to USB and Ethernet (registered trademark) standards, and the like, and a wireless communication interface conforming to wireless LAN, Bluetooth (registered trademark), and mobile phone network (3G, 4G, or the like) standards, and the like. An interface for external display conforming to HDMI (registered trademark), and DisplayPort standards, and the like is also included in the I/F 214. The above-described projector 100 also communicates with the PC 201 via the I/F 214.

A display apparatus 215 is a liquid crystal display (LCD), for example, and an OS or an application program performs various displays on this display device. The CPU 210 controls display of the display apparatus 215.

An input device 216 is one or more input devices for a user to give an input to the PC 201, such as a keyboard and a pointing device.

When an instruction to set the printed matter projection mode is issued by operating the input device 216, for example, the CPU 210 transmits a printed matter projection mode setting request to the projector 100 through the I/F 214.

Also, the CPU 210 can detect whether or not the projector 100 is set to the printed matter projection mode, by acquiring state information from the projector 100, or receiving a notification from the projector 100. When detecting that the projector 100 is set to the printed matter projection mode, the CPU 210 applies image processing for reducing the sharpness of an image to be transmitted to the projector 100. The CPU 210 then transmits the image whose sharpness is reduced to the projector 100 through the I/F 214. Also, after transmitting the printed matter projection mode setting request or receiving a printed matter projection mode setting completion notification from the projector 100, the CPU 210 reduces the sharpness of the image and transmits the image to the projector 100.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-186843, filed on Sep. 27, 2017, which is hereby incorporated by reference herein in its entirety.

What is claimed is:

1. A display apparatus comprising:
an optical modulator having a plurality of pixels and modulates light from a light source;
a projection optical system that projects an optical image formed by light modulated by the optical modulator; and
a controller,
wherein, in a case where the optical image is to be projected onto printed matter, the controller reduces sharpness of the optical image more than in a case where the optical image is not to be projected onto printed matter.

2. The display apparatus according to claim 1,
wherein the controller reduces the sharpness of the optical image by controlling an in-focus distance of the projection optical system.

3. The display apparatus according to claim 1,
wherein the controller reduces the sharpness of the optical image by tilting the projection optical system.

4. The display apparatus according to claim 1, further comprising:
an optical path shift device that shifts an optical path of the optical image,
wherein the controller reduces the sharpness of the optical image by driving the optical path shift device.

5. The display apparatus according to claim 1,
wherein, if the display apparatus is set to a printed matter projection mode, the controller determines that the optical image is to be projected onto printed matter.

6. The display apparatus according to claim 1,
wherein, if it is determined that printed matter is present on a projection plane of the optical image, the controller determines that the optical image is to be projected onto printed matter.

7. The display apparatus according to claim 1,
wherein the optical modulator modulates the light by controlling transmittance or reflectance of the plurality of pixels based on image data.

8. The display apparatus according to claim 7,
wherein, if an amount or a ratio of high-frequency components of an image expressed by the image data exceeds a predetermined threshold, the controller does not reduce the sharpness of the optical image even if the optical image is to be projected onto printed matter.

9. The display apparatus according to claim 1,
wherein, if a projection distance of the optical image is more than or equal to a predetermined value, the controller does not reduce the sharpness of the optical image even if the optical image is to be projected onto printed matter.

10. The display apparatus according to claim 1,
wherein the controller does not reduce the sharpness of the optical image during execution of on-screen display (OSD) even if the optical image is to be projected onto printed matter.

11. The display apparatus according to claim 1,
wherein, if an amount of bokeh of the projected optical image changes depending on a position on the optical image, the controller determines a position at which an image of on-screen display (OSD) is to be displayed to a position at which the amount of bokeh is less than at another position.

12. The display apparatus according to claim 11,
wherein the controller:
reduces the sharpness of the optical image by tilting the projection optical system if the on-screen display (OSD) is not executed, and
reduces the sharpness of the optical image by controlling an in-focus distance of the projection optical system during execution of the OSD.

13. The display apparatus according to claim 1,
wherein the controller reduces the sharpness of the optical image more than in a case where the optical image is not to be projected onto printed matter, in accordance with an instruction from an external apparatus.

14. A method for controlling a display apparatus including an optical modulator that has a plurality of pixels and modulates light from a light source and a projection optical system configured to project an optical image formed by light modulated by the optical modulator, the method comprising:
reducing, if the optical image is to be projected onto printed matter, sharpness of the optical image more than in a case where the optical image is not to be projected onto printed matter.

15. A non-transitory computer-readable medium storing a program executable by a computer of a display apparatus that comprises
an optical modulator having a plurality of pixels and modulates light from a light source; and
a projection optical system that projects an optical image formed by light modulated by the optical modulator, wherein the program, when executed by the computer, causes the computer to function as:
a controller, which, in a case where the optical image is to be projected onto printed matter, reduces sharpness of the optical image more than in a case where the optical image is not to be projected onto printed matter.
